(19) United States
(12) Patent Application Publication
(10) Pub. No.: US 2018/0218747 A1
(43) Pub. Date: Aug. 2, 2018

(54) Audio Device Filter Modification

(71) Applicant: Bose Corporation, Framingham, MA (US)

(72) Inventors: Amir Moghimi, Sutton, MA (US); William Berardi, Grafton, MA (US); David Crist, Watertown, MA (US)

(21) Appl. No.: 15/418,687

(22) Filed: Jan. 28, 2017

(51) Int. Cl. G10L 21/028; G10L 25/81; G10L 21/0216

(52) U.S. Cl. CPC G10L 21/028; G10L 25/81; G10L 25/21; G10L 2021/02166; G10L 21/0216

(57) ABSTRACT

An audio device with a number of microphones that are configured into a microphone array. An audio signal processing system in communication with the microphone array is configured to derive a plurality of audio signals from the plurality of microphones, use prior audio data to operate a filter topology that processes audio signals so as to make the array more sensitive to desired sounds than to undesired sounds, categorize received sounds as one of desired sounds or undesired sounds, and use the categorized received sounds and the categories of the received sounds to modify the filter topology.

### BACKGROUND

This disclosure relates to an audio device that has a microphone array.

Beamformers are used in audio devices to improve detection of desired sounds such as voice commands directed at the device, in the presence of noise. Beamformers are typically based on audio data collected in a carefully-controlled environment, where the data can be labelled as either desired or undesired. However, when the audio device is used in real-world situations, a beamformer that is based on idealized data is only an approximation and thus may not perform as well as it should.

### SUMMARY

All examples and features mentioned below can be combined in any technically possible way.

In one aspect, an audio device includes a plurality of spatially-separated microphones that are configured into a microphone array, wherein the microphones are adapted to receive sound. There is a processing system in communication with the microphone array and configured to derive a plurality of audio signals from the plurality of microphones, use prior audio data to operate a filter topology that processes audio signals so as to make the array more sensitive to desired sounds than to undesired sounds, categorize received sounds as one of desired sounds or undesired sounds, and use the categorized received sounds and the categories of the received sounds to modify the filter topology. In one non-limiting example, desired and undesired sounds modify the filter topology differently.

Embodiments may include one of the following features, or any combination thereof. The audio device may also include a detection system that is configured to detect a type of sound source from which audio signals are being derived. The audio signals may be derived from a certain type of sound source are not used to modify the filter topology. The certain type of sound source may include a voice-based sound source. The detection system may include a voice activity detector that is configured to be used to detect a voice-based sound source. The audio signals may include multi-channel audio recordings, or cross-power spectral density matrices, for example.

Embodiments may include one of the following features, or any combination thereof. The audio signal processing system may be further configured to compute a confidence score for received sounds, wherein the confidence score is used in the modification of the filter topology. The confidence score may be used to weight the contribution of the received sounds to the modification of the filter topology. Computing the confidence score may be based on a degree of confidence that received sounds include a wakeup word.

Embodiments may include one of the following features, or any combination thereof. The received sounds can be collected over time, and categorized received sounds that are collected over a particular time-period can be used to modify the filter topology. The received sound collection time-period may or may not be fixed. Older received sounds may have less effect on filter topology modification than do newer collected received sounds. The effect of collected received sounds on the filter topology modification may, in one example, decay at a constant rate. The audio can also include a detection system that is configured to detect a change in the environment of the audio device. Which particular collected received sounds that are used to modify the filter topology may be based on the detected change in the environment. In one example, when a change in the environment of the audio device is detected, received sounds that were collected before the change in the environment of the audio device was detected are no longer used to modify the filter topology.

Embodiments may include one of the following features, or any combination thereof. The audio signals can include multi-channel representations of sound fields detected by the microphone array, with at least one channel for each microphone. The audio signals can also include metadata. The audio device can include a communication system that is configured to transmit audio signals to a server. The communication system can also be configured to receive modified filter topology parameters from the server. A modified filter topology may be based on a combination of the modified filter topology parameters received from the server, and categorized received sounds.

In another aspect, an audio device includes a plurality of spatially-separated microphones that are configured into a microphone array, wherein the microphones are adapted to receive sound, and a processing system in communication with the microphone array and configured to derive a plurality of audio signals from the plurality of microphones, use prior audio data to operate a filter topology that processes audio signals so as to make the array more sensitive to desired sound than to undesired sound, categorize received sounds as one of desired sounds or undesired sounds, determine a confidence score for received sounds, and use the categorized received sounds, the categories of the received sounds, and the confidence score, to modify the filter topology, wherein received sounds are collected over time, and categorized received sounds that are collected over a particular time-period are used to modify the filter topology.

In another aspect, an audio device includes a plurality of spatially-separated microphones that are configured into a microphone array, wherein the microphones are adapted to receive sound, a sound source detection system that is configured to detect a type of sound source from which audio signals are being derived, an environmental change detection system that is configured to detect a change in the environment of the audio device, and a processing system in communication with the microphone array, the sound source detection system, and the environmental change detection system, and configured to derive a plurality of audio signals from the plurality of microphones, use prior audio data to operate a filter topology that processes audio signals so as to make the array more sensitive to desired sound than to undesired sound, categorize received sounds as one of desired sounds or undesired sounds, determine a confidence score for received sounds, and use the categorized received sounds, the categories of the received sounds, and the confidence score, to modify the filter topology, wherein received sounds are collected over time, and categorized received sounds that are collected over a particular time-period are used to modify the filter topology. In one non-limiting example, the audio device further includes a communication system that is configured to transmit audio signals to a server, and the audio signals comprise multi-channel representations of sound fields detected by the microphone array, comprising at least one channel for each microphone.

### BRIEF DESCRIPTION OF THE DRAWINGS

FIG. 1 is schematic block diagram of an audio device and an audio device filter modification system.

FIG. 2 illustrates an audio device such as that depicted in FIG. 1, in use in a room.

### DETAILED DESCRIPTION

In an audio device that has two or more microphones that are configured into a microphone array, an audio signal processing algorithm or topology, such as a beamforming algorithm, is used to help distinguish desired sounds (such as a human voice) from undesired sounds (such as noise). The audio signal processing algorithm can be based on controlled recordings of idealized sound fields produced by desired and undesired sounds. These recordings are preferably but not necessarily taken in an anechoic environment. The audio signal processing algorithm is designed to produce optimal rejection of undesired sound sources relative to the desired sound sources. However, the sound fields that are produced by desired and undesired sound sources in the real world do not correspond with the idealized sound fields that are used in the algorithm design.

The audio signal processing algorithm can be made more accurate for use in the real-world, as compared to an anechoic environment, by the present filter modification. This is accomplished by modifying the algorithm design with real-world audio data, taken by the audio device while the device is in-use in the real world. Sounds that are determined to be desired sounds can be used to modify the set of desired sounds that is used by the beamformer. Sounds that are determined to be undesired sounds can be used to modify the set of undesired sounds that is used by the beamformer. Desired and undesired sounds thus modify the beamformer differently. The modifications to the signal processing algorithm are made autonomously and passively, without the need for any intervention by a person, or any additional equipment. A result is that the audio signal processing algorithm in use at any particular time can be based on a combination of pre-measured and in-situ sound field data. The audio device is thus better able to detect desired sounds in the presence of noise and other undesired sounds.

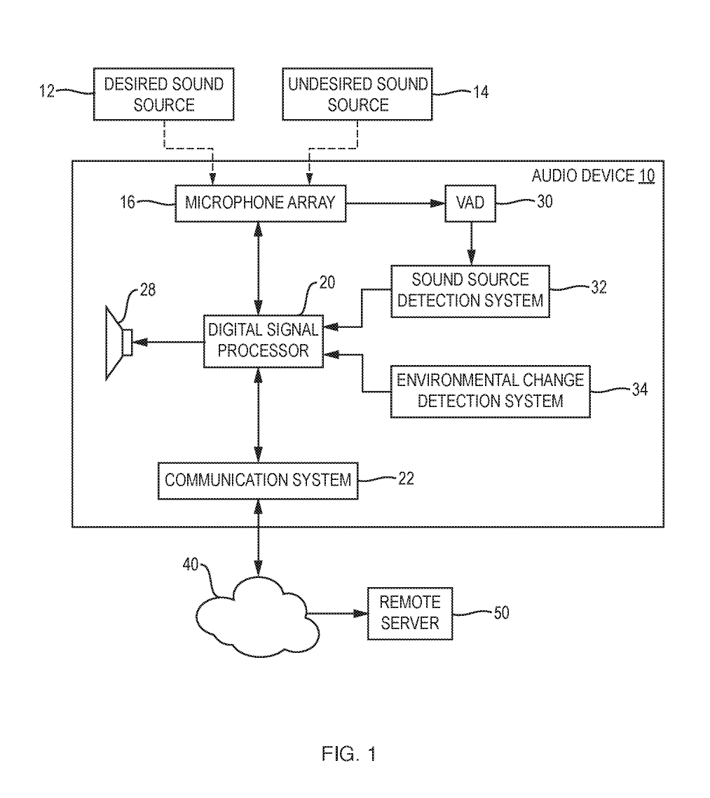

An exemplary audio device 10 is depicted in FIG. 1. Device 10 has a microphone array 16 that comprises two or more microphones that are in different physical locations. Microphone arrays can be linear or not, and can include two microphones, or more than two microphones. The microphone array can be a stand-alone microphone array, or it can be part of an audio device such as a loudspeaker or headphones, for example. Microphone arrays are well known in the art and so will not be further described herein. The microphones and the arrays are not restricted to any particular microphone technology, topology, or signal processing. Any references to transducers or headphones or other types of audio devices should be understood to include any audio device, such as home theater systems, wearable speakers, etc.

One use example of audio device 10 is as a hands-free, voice-enabled speaker, or “smart speaker,” examples of which include Amazon Echo™ and Google Home™. A smart speaker is a type of intelligent personal assistant that includes one or more microphones and one or more speakers, and has processing and communication capabilities. Device 10 could alternatively be a device that does not function as a smart speaker, but still have a microphone array and processing and communication capabilities. Examples of such alternative devices can include portable wireless speakers such as a Bose SoundLink® wireless speaker. In some examples, two or more devices in combination, such as an Amazon Echo Dot and a Bose SoundLink® speaker provide the smart speaker. Yet another example of an audio device is a speakerphone. Also, the smart speaker and speakerphone functionalities could be enabled in a single device.

Audio device 10 is often used in a home or office environment where there can be varied types and levels of noise. In such environments, there are challenges associated with successfully detecting voices, for example voice commands. Such challenges include the relative locations of the source(s) of desired and undesired sounds, the types and loudness of undesired sounds (such as noise), and the presence of articles that change the sound field before it is captured by the microphone array, such as sound reflecting and absorbing surfaces, which may include walls and furniture, for example.

Audio device 10 is able to accomplish the processing required in order to use and modify the audio processing algorithm (e.g., the beamformer), as described herein. Such processing is accomplished by the system labelled “digital signal processor” (DSP) 20. It should be noted that DSP 20 may actually comprise multiple hardware and firmware aspects of audio device 10. However, since audio signal processing in audio devices is well known in the art, such particular aspects of DSP 20 do not need to be further illustrated or described herein. The signals from the microphones of microphone array 16 are provided to DSP 20. The signals are also provided to voice activity detector (VAD) 30. Audio device 10 may (or may not) include electro-acoustic transducer 28 so that it can play sound.

Microphone array 16 receives sound from one or both of desired sound source 12 and undesired sound source 14. As used herein, “sound,” “noise,” and similar words refer to audible acoustic energy. At any given time, both, either, or none of the desired and undesired sound sources may be producing sound that is received by microphone array 16. And, there may be one, or more than one, source of desired and/or undesired sound. In one non-limiting example, audio device 10 is adapted to detect human voices as “desired” sound sources, with all other sounds being “undesired.” In the example of a smart speaker, device 10 may be continually working to sense a “wakeup word.” A wakeup word can be a word or phrase that is spoken at the beginning of a command meant for the smart speaker, such as “okay Google,” which can be used as the wakeup word for the Google Home™ smart speaker product. Device 10 can also be adapted to sense (and, in some cases, parse) utterances (i.e., speech from a user) that follow wakeup words, such utterances commonly interpreted as commands meant to be executed by the smart speaker or another device or system that is in communication with the smart speaker, such as processing accomplished in the cloud. In all types of audio devices, including but not limited to smart speakers or other devices that are configured to sense wakeup words, the subject filter modification helps to improve voice recognition (and, thus, wakeup word recognition) in environments with noise.

During active or in-situ use of an audio system, the microphone array audio signal processing algorithm that is used to help distinguish desired sounds from undesired sounds does not have any explicit identification of whether sounds are desired or undesired. However, the audio signal processing algorithm relies on this information. Accordingly, the present audio device filter modification methodology includes one or more approaches to address the fact that input sounds are not identified as either desired or undesired. Desired sounds are typically human speech, but need not be limited to human speech and instead could include sound such as non-speech human sounds (e.g., a crying baby if the smart speaker includes a baby monitor application, or the sound of a door opening or glass breaking if the smart speaker includes a home security application). Undesired sounds are all sounds other than desired sounds. In the case of a smart speaker or other device that is adapted to sense a wakeup word or other speech that is addressed to the device, the desired sounds are speech addressed to the device, and all other sounds are undesired.

A first approach to address distinguishing between desired and undesired sounds in-situ involves considering all of, or at least most of, the audio data that the microphone array receives in-situ, as undesired sound. This is generally the case with a smart speaker device used in a home, say a living room or kitchen. In many cases, there will be almost continual noise and other undesired sounds (i.e., sounds other than speech that is directed at the smart speaker), such as appliances, televisions, other audio sources, and people talking in the normal course of their lives. The audio signal processing algorithm (e.g., the beamformer) in this case uses only pre-recorded desired sound data as its source of “desired” sound data, but updates its undesired sound data with sound recorded in-situ. The algorithm thus can be tuned as it is used, in terms of the undesired data contribution to the audio signal processing.

Another approach to address distinguishing between desired and undesired sounds in-situ involves detecting the type of sound source and deciding, based on this detection, whether to use the data to modify the audio processing algorithm. For example, audio data of the type that the audio device is meant to collect can be one category of data. For a smart speaker or a speaker phone or other audio device that is meant to collect human voice data that is directed at the device, the audio device can include the ability to detect human voice audio data. This can be accomplished with a voice activity detector (VAD) 30, which is an aspect of audio devices that is able to distinguish if sound is an utterance or not. VADs are well known in the art and so do not need to be further described. VAD 30 is connected to sound source detection system 32, which provides sound source identification information to DSP 20. For example, data collected via VAD 30 can be labelled by system 32 as desired data. Audio signals that do not trigger VAD 30 can be considered to be undesired sound. The audio processing algorithm update process could then either include such data in the set of desired data, or exclude such data from the set of undesired data. In the latter case, all audio input that is not collected via the VAD is considered undesired data and can be used to modify the undesired data set, as described above.

Another approach to address distinguishing between desired and undesired sounds in-situ involves basing the decision on another action of the audio device. For example, in a speakerphone, all data collected while an active phone call is ongoing can be labeled as desired sound, with all other data being undesired. A VAD could be used in conjunction with this approach, potentially to exclude data during an active call that is not voice. Another example involves an “always listening” device that wakes up in response to a keyword; keyword data and data collected after the keyword (the following utterance) can be labeled as desired data, and all other data can be labeled as undesired. Known techniques such as keyword spotting and end-point detection can be used to detect the keyword and utterance.

Yet another approach to address distinguishing between desired and undesired sounds in-situ involves enabling the audio signal processing system (e.g., via DSP 20) to compute a confidence score for received sounds, where the confidence score relates to the confidence that the sound or sound segment belongs in the desired or undesired sound set. The confidence score can be used in the modification of the audio signal processing algorithm. For example, the confidence score can be used to weight the contribution of the received sounds to the modification of the audio signal processing algorithm. When the confidence that a sound is desired is high (e.g., when a wakeup word and utterance are detected), the confidence score can be set at 100%, meaning that the sound is used to modify the set of desired sounds used in the audio signal processing algorithm. If the confidence that a sound is desired or that a sound is undesired is less than 100%, a confidence weighting of less than 100% can be assigned such that the contribution of the sound sample to the overall result is weighted. Another advantage of this weighting is that previously-recorded audio data can be re-analyzed and its label (desired/undesired) confirmed or changed based on new information. For example, when a keyword spotting algorithm is also being used, once the keyword is detected there can be a high confidence that the following utterance is desired.

The above approaches to address distinguishing between desired and undesired sounds in-situ can be used by themselves, or in any desirable combination, with the goal of modifying one or both of the desired and undesired sound data sets that are used by the audio processing algorithm to help distinguish desired sounds from undesired sounds when the device is used, in-situ.

Audio device 10 includes capabilities to record different types of audio data. The recorded data could include a multi-channel representation of the sound field. This multi-channel representation of the sound field would typically include at least one channel for each microphone of the array. The multiple signals originating from different physical locations assists with localization of the sound source. Also, metadata (such as the date and time of each recording) can be recorded as well. Metadata could be used, for example, to design different beamformers for different times of day and different seasons, to account for acoustic differences between these scenarios. Direct multi-channel recordings are simple to gather, require minimal processing, and capture all audio information—no audio information is discarded that may be of use to audio signal processing algorithm design or modification approaches. Alternatively, the recorded audio data can include cross power spectrum matrices that are measures of data correlation on a per frequency basis. These data can be calculated over a relatively short time period, and can be averaged or otherwise amalgamated if longer-term estimates are required or useful. This approach may use less processing and memory than multi-channel data recording.

The modifications of the audio processing algorithm (e.g., the beamformer) design with audio data that is taken by the audio device while the device is in-situ (i.e., in-use in the real world), can be configured to account for changes that take place as the device is used. Since the audio signal processing algorithm in use at any particular time is usually based on a combination of pre-measured and in-situ collected sound field data, if the audio device is moved or its surrounding environment changes (for example, it is moved to a different location in a room or house, or it is moved relative to sound reflecting or absorbing surfaces such as walls and furniture, or furniture is moved in the room), prior-collected in situ data may not be appropriate for use in the current algorithm design. The current algorithm design will be most accurate if it properly reflects the current specific environmental conditions. Accordingly, the audio device can include the ability to delete or replace old data, which can include data that was collected under now-obsolete conditions.

There are several specific manners contemplated that are meant to help ensure that the algorithm design is based on the most relevant data. One manner is to only incorporate data collected since a fixed amount of time in the past. As long as the algorithm has enough data to satisfy the needs of the particular algorithm design, older data can be deleted. This can be thought of as a moving window of time over which collected data is used by the algorithm. This helps to ensure that the most relevant data to the most current conditions of the audio device are being used. Another manner is to have sound field metrics decay with a time constant. The time constant could be predetermined, or could be variable based on metrics such as the types and quantity of audio data that has been collected. For example, if the design procedure is based on calculation of a cross-power-spectral-density (PSD) matrix, a running estimate can be kept that incorporates new data with a time constant, such as:

Cₜ(f)=(1−α)Cₜ₋₁(f)+αĈₜ(f)

where Cₜ(f) is the current running estimate of the cross-PSD, Cₜ₋₁(f) is the running estimate at the last time step, Ĉₜ(f) is the cross-PSD estimated only from data gathered within the last time step and α is an update parameter. With this (or a similar scheme), older data is de-emphasized as time goes on.

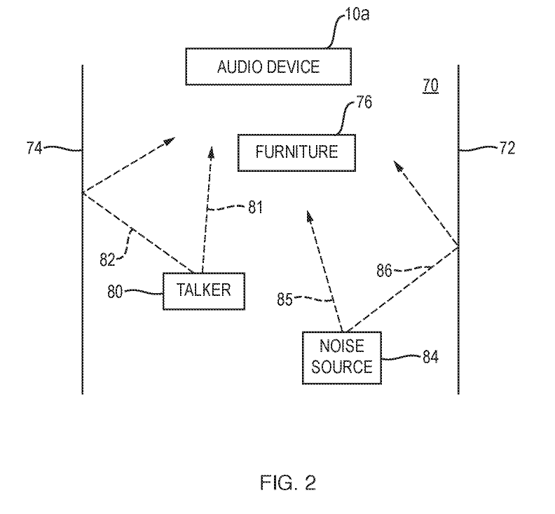

As described above, movement of the audio device, or changes to the environment around the audio device that have an effect on the sound field detected by the device, may change the sound field in ways that makes the use of pre-move audio data problematic to the accuracy of the audio processing algorithm. For example, FIG. 2 depicts local environment 70 for audio device 10a. Sound received from talker 80 moves to device 10a via many paths, two of which are shown—direct path 81 and indirect path 82 in which sound is reflected from wall 74. Similarly, sound from noise source 84 (e.g., a TV or refrigerator) moves to device 10a via many paths, two of which are shown—direct path 85 and indirect path 86 in which sound is reflected from wall 72. Furniture 76 may also have an effect on sound transmission, e.g., by absorbing or reflecting sound.

Since the sound field around an audio device can change, it may be best, to the extent possible, to discard data collected before the device is moved or items in the sound field are moved. In order to do so, the audio device should have some way of determining when it has been moved, or the environment has changed. This is broadly indicated in FIG. 1 by environmental change detection system 34. One manner of accomplishing system 34 could be to allow a user to reset the algorithm via a user interface, such as a button on the device or on a remote-control device or a smartphone app that is used to interface with the device. Another way is to incorporate an active, non-audio based motion detection mechanism in the audio device. For example, an accelerometer can be used to detect motion and the DSP can then discard data collected before the motion. Alternatively, if the audio device includes an echo canceller, it is known that its taps will change when the audio device is moved. The DSP could thus use changes in echo canceller taps as an indicator of a move. When all past data is discarded, the state of the algorithm can remain at its current state until sufficient new data has been collected. A better solution in the case of data deletion may be to revert to the default algorithm design, and re-start modifications based on newly-collected audio data.

When multiple separate audio devices are in use, by the same user or different users, the algorithm design changes can be based on audio data collected by more than one audio device. For example, if data from many devices contributes to the current algorithm design, the algorithm may be more accurate for average real-world uses of the device, as compared to its initial design based on carefully-controlled measurements. To accommodate this, audio device 10 may include means to communicate with the outside world, in both directions. For example, communication system 22 can be used to communicate (wirelessly or over wires) to one or more other audio devices. In the example shown in FIG. 1, communication system 22 is configured to communicate with remote server 50 over internet 40. If multiple separate audio devices communicate with server 50, server 50 can amalgamate the data and use it to modify the beamformer, and push the modified beamformer parameters to the audio devices, e.g., via cloud 40 and communication system 22. A consequence of this approach is that if a user opts out of this data-collection scheme, the user can still benefit from the updates that are made to the general population of users. The processing represented by server 50 can be provided by a single computer (which could be DSP 20 or server 50), or a distributed system, coextensive with or separate from device 10 or server 50. The processing may be accomplished entirely locally to one or more audio devices, entirely in the cloud, or split between the two. The various tasks accomplished as described above can be combined together or broken down into more sub-tasks. Each task and sub-task may be performed by a different device or combination of devices, locally or in a cloud-based or other remote system.

The subject audio device filter modification can be used with processing algorithms other than beamformers, as would be apparent to one skilled in the art. Several non-limiting examples include multi-channel Wiener filters (MWFs), which are very similar to beamformers; the collected desired and undesired signal data could be used in almost the same way as with a beamformer. Also, array-based time-frequency masking algorithms can be used. These algorithms involve decomposing the input signal into time-frequency bins and then multiplying each bin by a mask that is an estimate of how much the signal in that bin is desired vs. undesired. There are a multitude of mask estimation techniques, most of which could benefit from real-world examples of desired and undesired data. Further, machine-learned speech enhancement, using neural networks or a similar construct, could be used. This is critically dependent on having recordings of desired and undesired signals; this could be initialized with something generated in the lab, but would improve greatly with real-world samples.

Elements of figures are shown and described as discrete elements in a block diagram. These may be implemented as one or more of analog circuitry or digital circuitry. Alternatively, or additionally, they may be implemented with one or more microprocessors executing software instructions. The software instructions can include digital signal processing instructions. Operations may be performed by analog circuitry or by a microprocessor executing software that performs the equivalent of the analog operation. Signal lines may be implemented as discrete analog or digital signal lines, as a discrete digital signal line with appropriate signal processing that is able to process separate signals, and/or as elements of a wireless communication system.

When processes are represented or implied in the block diagram, the steps may be performed by one element or a plurality of elements. The steps may be performed together or at different times. The elements that perform the activities may be physically the same or proximate one another, or may be physically separate. One element may perform the actions of more than one block. Audio signals may be encoded or not, and may be transmitted in either digital or analog form. Conventional audio signal processing equipment and operations are in some cases omitted from the drawing.

Embodiments of the systems and methods described above comprise computer components and computer-implemented steps that will be apparent to those skilled in the art. For example, it should be understood by one of skill in the art that the computer-implemented steps may be stored as computer-executable instructions on a computer-readable medium such as, for example, floppy disks, hard disks, optical disks, Flash ROMS, nonvolatile ROM, and RAM. Furthermore, it should be understood by one of skill in the art that the computer-executable instructions may be executed on a variety of processors such as, for example, microprocessors, digital signal processors, gate arrays, etc. For ease of exposition, not every step or element of the systems and methods described above is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the disclosure.

A number of implementations have been described. Nevertheless, it will be understood that additional modifications may be made without departing from the scope of the inventive concepts described herein, and, accordingly, other embodiments are within the scope of the following claims.

1. An audio device, comprising:
a plurality of spatially-separated microphones that are configured into a microphone array, wherein the microphones are adapted to receive sound; and
a processing system in communication with the microphone array and configured to:
derive a plurality of audio signals from the plurality of microphones;
use prior audio data to operate a filter topology that processes audio signals so as to make the array more sensitive to desired sound than to undesired sound;
categorize received sounds as one of desired sounds or undesired sounds; and
use the categorized received sounds, and the categories of the received sounds, to modify the filter topology.

2. The audio device of claim 1, further comprising a detection system that is configured to detect a type of sound source from which audio signals are being derived.

3. The audio device of claim 2, wherein the audio signals derived from a certain type of sound source are not used to modify the filter topology.

4. The audio device of claim 3, wherein the certain type of sound source comprises a voice-based sound source.

5. The audio device of claim 2, wherein the detection system comprises a voice activity detector that is configured to be used to detect a voice-based sound source.

6. The audio device of claim 1, wherein the audio signal processing system is further configured to compute a confidence score for received sounds, wherein the confidence score is used in the modification of the filter topology.

7. The audio device of claim 6, wherein the confidence score is used to weight the contribution of the received sounds to the modification of the filter topology.

8. The audio device of claim 6, wherein computing the confidence score is based on a degree of confidence that received sounds include a wakeup word.

9. The audio device of claim 1, wherein received sounds are collected over time, and categorized received sounds that are collected over a particular time-period are used to modify the filter topology

10. The audio device of claim 1, wherein the received sound collection time-period is fixed.

11. The audio device of claim 1, wherein older received sounds have less effect on filter topology modification than do newer collected received sounds.

12. The audio device of claim 11, wherein the effect of collected received sounds on the filter topology modification decays at a constant rate.

13. The audio device of claim 1, further comprising a detection system that is configured to detect a change in the environment of the audio device.

14. The audio device of claim 13, wherein which of the collected received sounds that are used to modify the filter topology, is based on the detected change in the environment.

15. The audio device of claim 14, wherein when a change in the environment of the audio device is detected, received sounds that were collected before the change in the environment of the audio device was detected, are no longer used to modify the filter topology.

16. The audio device of claim 1, further comprising a communication system that is configured to transmit audio signals to a server.

17. The audio device of claim 16, wherein the communication system is further configured to receive modified filter topology parameters from the server.

18. The audio device of claim 17, wherein a modified filter topology is based on a combination of the modified filter topology parameters received from the server, and categorized received sounds.

19. The audio device of claim 1, wherein the audio signals comprise multi-channel representations of sound fields detected by the microphone array, comprising at least one channel for each microphone.

20. The audio device of claim 19, wherein the audio signals further comprise metadata.

21. The audio device of claim 1, wherein the audio signals comprise multi-channel audio recordings.

22. The audio device of claim 1, wherein the audio signals comprise cross-power spectral density matrices.

23. The audio device of claim 1, where desired and undesired sounds modify the filter topology differently.

24. An audio device, comprising:
a plurality of spatially-separated microphones that are configured into a microphone array, wherein the microphones are adapted to receive sound; and
a processing system in communication with the microphone array and configured to:
derive a plurality of audio signals from the plurality of microphones;
use prior audio data to operate a filter topology that processes audio signals so as to make the array more sensitive to desired sound than to undesired sound;
categorize received sounds as one of desired sounds or undesired sounds;
determine a confidence score for received sounds; and
use the categorized received sounds, the categories of the received sounds, and the confidence score, to modify the filter topology, wherein received sounds are collected over time, and categorized received sounds that are collected over a particular time-period are used to modify the filter topology.

25. An audio device, comprising:
a plurality of spatially-separated microphones that are configured into a microphone array, wherein the microphones are adapted to receive sound;
a sound source detection system that is configured to detect a type of sound source from which audio signals are being derived;
an environmental change detection system that is configured to detect a change in the environment of the audio device; and
a processing system in communication with the microphone array, the sound source detection system, and the environmental change detection system, and configured to:
derive a plurality of audio signals from the plurality of microphones;
use prior audio data to operate a filter topology that processes audio signals so as to make the array more sensitive to desired sound than to undesired sound;
categorize received sounds as one of desired sounds or undesired sounds;
determine a confidence score for received sounds; and
use the categorized received sounds, the categories of the received sounds, and the confidence score, to modify the filter topology, wherein received sounds are collected over time, and categorized received sounds that are collected over a particular time-period are used to modify the filter topology.

26. The audio device of claim 25, further comprising a communication system that is configured to transmit audio signals to a server, and wherein the audio signals comprise multi-channel representations of sound fields detected by the microphone array, comprising at least one channel for each microphone.
